(19) United States
(12) Patent Application Publication
(10) Pub. No.: US 2024/0291061 A1
(43) Pub. Date: Aug. 29, 2024

(54) ADJUSTABLE HEATING FOR A MIXED CHEMISTRY BATTERY

(71) Applicant: GM GLOBAL TECHNOLOGY OPERATIONS LLC, Detroit, MI (US)

(72) Inventors: Jian Yao; Yue-Yun Wang, Troy, MI (US); Zhenwen Hu, Shanghai (CN); Chengwu Duan, Shanghai (CN); Shuonan Xu, Troy, MI (US)

(21) Appl. No.: 18/302,455

(22) Filed: Apr. 18, 2023

(30) Foreign Application Priority Data
Feb. 28, 2023 (CN) 202310181954.6

(51) Int. Cl. H01M 10/615; H01M 10/625; H01M 10/6555

(52) U.S. Cl. CPC H01M 10/615; H01M 10/625; H01M 10/6555

(57) ABSTRACT

A mixed chemistry battery including a sensing cell having a first chemistry, a battery cell having a second chemistry that is different than the first chemistry. The mixed chemistry battery also includes a sensor configured to measure a temperature of the mixed chemistry battery and a heating system configured to heat the second battery cell. The mixed chemistry battery further includes a battery monitoring system configured to selectively connect the heating system to at least one of the first battery cell and the second battery cell based upon the temperature of the mixed chemistry battery.

### CROSS-REFERENCE TO RELATED APPLICATION

This application claims the benefit of Chinese Application No. 202310181954.6, filed on Feb. 28, 2023, the disclosure of which is incorporated herein by reference in its entirety.

### INTRODUCTION

The disclosure relates to mixed chemistry batteries. More specifically, the disclosure relates to the adjustable heating of a mixed chemistry battery.

Lithium-ion batteries are used in a variety of applications, from electric vehicles to residential batteries to grid-scale applications. In general, the term lithium-ion battery refers to a wide array of battery chemistries that each charge and discharge using reactions from a lithiated metal oxide cathode and a graphite anode. As used herein, a mixed chemistry battery is a lithium-ion battery that includes battery cells that have at least two different chemistries. Two of the more commonly used lithium-ion chemistries are nickel manganese cobalt (NCM) and lithium iron phosphate (LFP). In general, LFP batteries are less expensive to manufacture than NCM batteries and NCM batteries have higher power rating and energy density compared to LFP batteries. In general, NCM batteries have better performance than LFP batteries at very low temperatures, (i.e., temperatures below approximately twenty degrees Celsius).

### SUMMARY

In one exemplary embodiment, a mixed chemistry battery of a vehicle is provided. The mixed chemistry battery includes a first battery cell having a first chemistry, a second battery cell having a second chemistry that is different than the first chemistry, and a sensor configured to measure a temperature of the mixed chemistry battery. The mixed chemistry battery also includes a heating system configured to heat the second battery cell and a battery monitoring system configured to selectively connect the heating system to at least one of the first battery cell and the second battery cell based upon the temperature of the mixed chemistry battery.

In addition to the one or more features described herein the first chemistry is nickel-manganese cobalt and the second chemistry is lithium iron phosphate.

In addition to the one or more features described herein the first battery cell is connected to the second battery cell in series.

In addition to the one or more features described herein the battery monitoring system is configured to connect the heating system to only the first battery cell based upon the temperature being below a first threshold value.

In addition to the one or more features described herein the battery monitoring system is configured to connect the heating system to the first battery cell and the second battery cell based upon the temperature being at least a first threshold value.

In addition to the one or more features described herein the heating system includes one or more resistive heating layers disposed adjacent to the second battery cell.

In addition to the one or more features described herein the heating system includes a cooling plate disposed adjacent to the first battery cell and the second battery cell.

In addition to the one or more features described herein the cooling plate is a liquid cooled and includes one or more valves that are controlled by the battery monitoring system based upon the temperature of the mixed chemistry battery.

In another exemplary embodiment, a method for heating a mixed chemistry battery having a first battery cell having a first chemistry and a second battery cell having a second chemistry that is different than the first chemistry is provided. The method includes monitoring a temperature of the mixed chemistry battery. Based on a determination that the temperature is below a first threshold value, the method includes connecting a heating system to only the first battery cell. Based on a determination that the temperature is at least the first threshold value, the method includes connecting the heating system to the first battery cell and to the second battery cell.

In addition to the one or more features described herein the first chemistry is nickel-manganese cobalt and the second chemistry is lithium iron phosphate.

In addition to the one or more features described herein the first battery cell is connected to the second battery cell in series.

In addition to the one or more features described herein the heating system includes one or more resistive heating layers disposed adjacent to the second battery cell.

In addition to the one or more features described herein the heating system includes a cooling plate disposed adjacent to the first battery cell and the second battery cell.

In addition to the one or more features described herein the cooling plate is a liquid cooled and includes one or more valves that are controlled by the battery monitoring system based upon the temperature of the mixed chemistry battery.

In addition to the one or more features described herein the method further includes deactivating the heating system based on a determination that the temperature is above a maximum threshold value.

In another exemplary embodiment, a method for heating a mixed chemistry battery having a first battery cell having a first chemistry and a second battery cell having a second chemistry that is different than the first chemistry is provided. The method includes monitoring a temperature of the mixed chemistry battery, monitoring a first state of charge of the first battery cell, and monitoring a second state of charge of the second battery cell. Based on a determination that the temperature is below a minimum threshold value, the method includes connecting a heating system to only the first battery cell. Based on a determination that the temperature is above an intermediate threshold value, the method includes connecting the heating system to only the second battery cell. Based on a determination that the temperature is above the intermediate threshold value and that a difference between the first state of charge and the second state of charge is less than maximum offset, the method includes connecting the heating system to the first battery cell and to the second battery cell.

In addition to the one or more features described herein the method also includes deactivating the heating system based on a determination that the temperature is above a maximum threshold value.

In addition to the one or more features described herein the first chemistry is nickel-manganese cobalt and the second chemistry is lithium iron phosphate.

In addition to the one or more features described herein the heating system includes one or more resistive heating layers disposed adjacent to the second battery cell.

In addition to the one or more features described herein the heating system includes a cooling plate disposed adjacent to the first battery cell and the second battery cell.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram illustrating a vehicle having a mixed chemistry battery in accordance with an exemplary embodiment;

FIG. 2 is a block diagram illustrating a mixed chemistry battery in accordance with an exemplary embodiment;

FIG. 3 is a schematic diagram illustrating a heating system for a mixed chemistry battery in accordance with an exemplary embodiment;

FIG. 4 is a schematic diagram illustrating a heating system for a mixed chemistry battery in accordance with an exemplary embodiment;

FIG. 5 is a schematic diagram illustrating a heating system for a mixed chemistry battery in accordance with an exemplary embodiment;

FIG. 6 is a schematic diagram illustrating a heating system for a mixed chemistry battery in accordance with an exemplary embodiment;

FIG. 7 is a flowchart illustrating a method for a heating system for mixed chemistry battery in accordance with an exemplary embodiment; and

FIG. 8 is a flowchart illustrating another method for a heating system for a mixed chemistry battery in accordance with an exemplary embodiment.

### DETAILED DESCRIPTION

The following description is merely exemplary in nature and is not intended to limit the present disclosure, its application or uses. Various embodiments of the disclosure are described herein with reference to the related drawings. Alternative embodiments of the disclosure can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship.

Turning now to an overview of the aspects of the disclosure, embodiments of the disclosure include a mixed chemistry battery having a first battery cell and a second battery cell. The first battery cell is a lithium-ion cell that includes a first chemistry that has a state-of-charge (SOC) that varies distinctly based on its open-circuit voltage (OCV) level, such as nickel manganese cobalt (NCM), nickel cobalt aluminum (NCA), lithium-ion manganese (LMO), lithium cobalt (LCO), or the like. The second battery cell is a lithium-ion cell that includes a second chemistry that has a SOC that does not vary distinctly based on its OCV level, such as lithium iron phosphate (LFP), lithium iron manganese phosphate (LFMP), sodium ion, or the like. As discussed above, NCM batteries have better performance than LFP batteries at very low temperatures, (i.e., temperatures below approximately twenty degrees Celsius). Accordingly, in exemplary embodiments, the mixed chemistry battery includes a heating system that is configured to heat the battery cells. In exemplary embodiments, the battery system is selectively powered by one or more of the battery cells based on the temperature of the mixed chemistry battery.

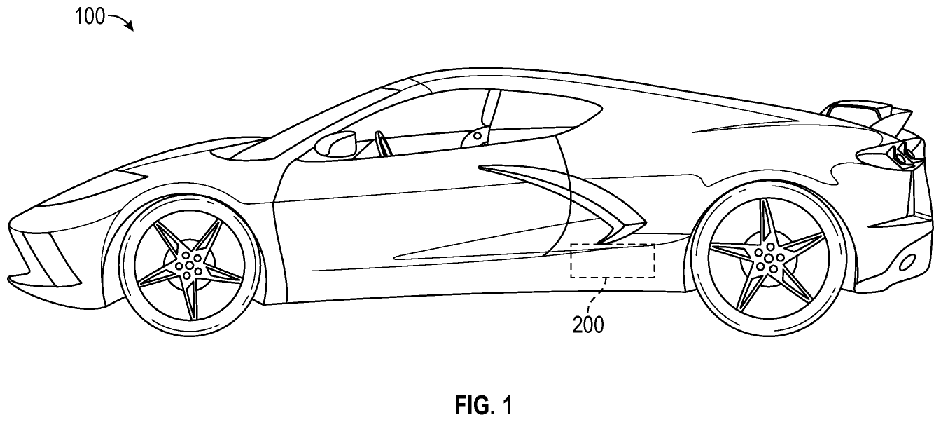

Referring now to FIG. 1, a schematic diagram of a vehicle 100 for use in conjunction with one or more embodiments of the present disclosure is shown. The vehicle 100 includes a mixed chemistry battery 200. In one embodiment, the vehicle 100 is a hybrid vehicle that utilizes both an internal combustion engine and an electric motor powered by the mixed chemistry battery 200. In another embodiment, the vehicle 100 is an electric vehicle that only utilizes electric motors that are powered by the mixed chemistry battery 200.

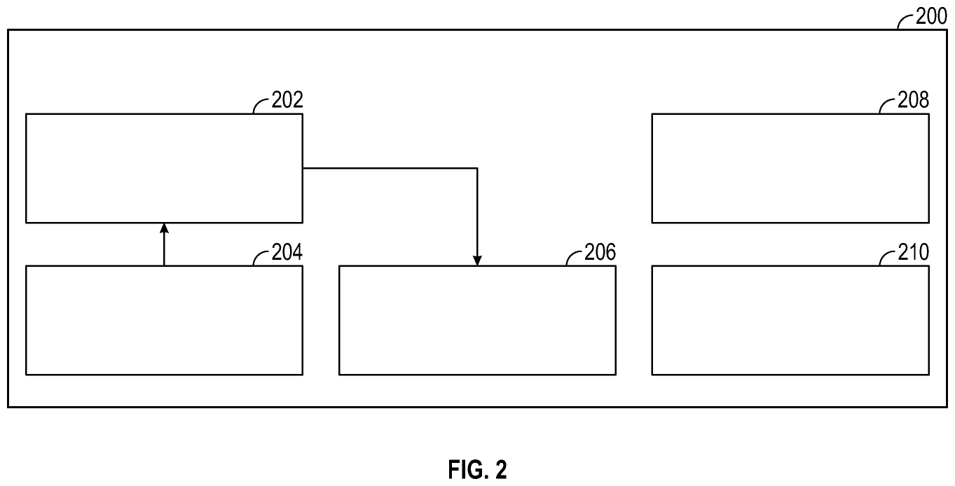

Referring now to FIG. 2 a block diagram of a mixed chemistry battery 200 in accordance with an exemplary embodiment is shown. As illustrated, the mixed chemistry battery 200 includes a battery management system 202, one or more sensors 204, a heating system 206, a first battery cell 208 and a second battery cell 210. In exemplary embodiments, the first battery cell 208 is one of several battery modules, each of which consists of a number of cells in the same chemistry, and the second battery cell 210 is one of several battery modules, each of which consists of a number of cells in another chemistry. The battery modules may be connected in a series configuration, a parallel configuration, or a combination of the two.

The battery monitoring system 202 is configured to measure, via sensors 204, the temperature of the mixed chemistry battery 200. In one embodiment, the battery monitoring system 202 is configured to measure, via sensors 204, a state-of-charge (SOC) of both the first battery cell 208 and the second battery cell 210 and perform other SOC estimation related functions. In exemplary embodiments, the battery monitoring system 202 is configured to control the operation of the heating system 206 based at least upon the temperature of the mixed chemistry battery 200. In one embodiment, the heating system 206 includes one or more switches and valves that are operated by the battery monitoring system 202 to control which battery cells the heating system 206 supplies heat to and to control which battery cells provide energy to the heating system 206.

In exemplary embodiments, the battery monitoring system 202 includes one or more of a general processor, a central processing unit, an application-specific integrated circuit (ASIC), a digital signal processor, a field-programmable gate array (FPGA), a digital circuit, an analog circuit, or combinations thereof. In one embodiment, the battery monitoring system 202 also includes a memory in communication with the processor and other components of the battery monitoring system 202.

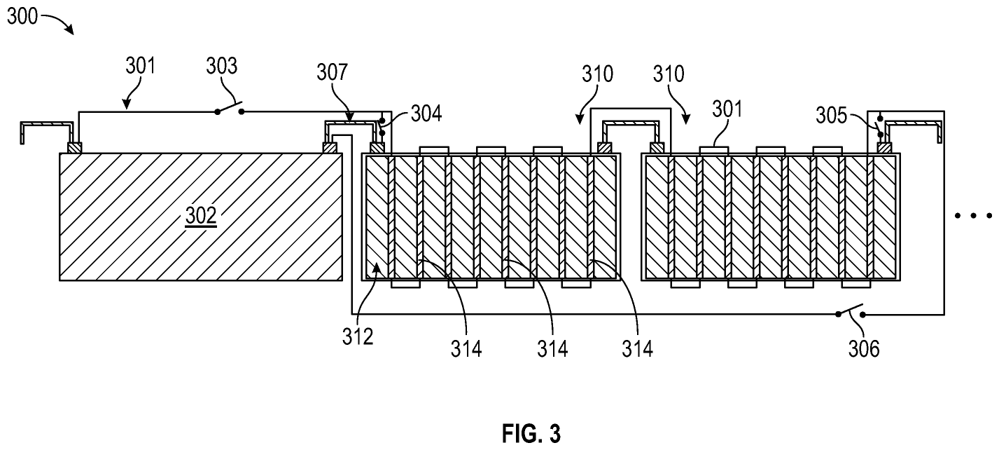

Referring now to FIG. 3 a schematic diagram illustrating a heating system for mixed chemistry battery 300 in accordance with an exemplary embodiment is shown. In exemplary embodiments, the mixed chemistry battery 300 includes a first battery pack 302 that includes a plurality of first battery cells (not shown) and one or more second battery packs 310 that each include a plurality of second battery cells 312. Each of the battery packs 302, 310 are electrically connected to each other via connectors 307, which may include wires and or conductive plates. In one embodiment, the battery packs 302, 310 are connected to one another, via the connectors 307, in a series configuration. In another embodiment, the battery packs 302, 310 are connected to one another, via the connectors 307, in a parallel configuration.

In exemplary embodiments, the mixed chemistry battery 300 includes a heating system that includes heating elements 314 that are disposed between the second battery cells 312. The heating elements 314 are resistive heating elements that can include, but are not limited to, a positive temperature coefficient (PTC) resistance heater, aluminum foil, nickel foil, and the like. In exemplary embodiments, the heating elements 314 are connected to each other via wires 301.

In exemplary embodiments, the heating elements 314 are selectively connected to one or more of the first battery pack 302 and the second battery pack 310 via the operation of switches 303, 304, 305, and 306. In exemplary embodiments, a battery management system is configured to control the heating system via switches 303, 304, 305, and 306. In one embodiment, the heating system is configured to be operated in three different modes. In the first mode, switch 303 is closed, switch 304 is open, switch 305 is open, and switch 306 is closed, as a result the heating elements 314 are only configured to receive power from the first battery pack 302. In a second mode, switch 303 is open, switch 304 is closed, switch 305 is closed, and switch 306 is open, as a result the heating elements 314 are only configured to receive power from the second battery packs 310. In a third mode, switch 303 is closed, switch 304 is open, switch 305 is closed, and switch 306 is open, as a result the heating elements 314 are configured to receive power from both the first battery pack 302 and the second battery packs 310. In addition, the heating system can be deactivated by opening switches 303, 304, 305, and 306.

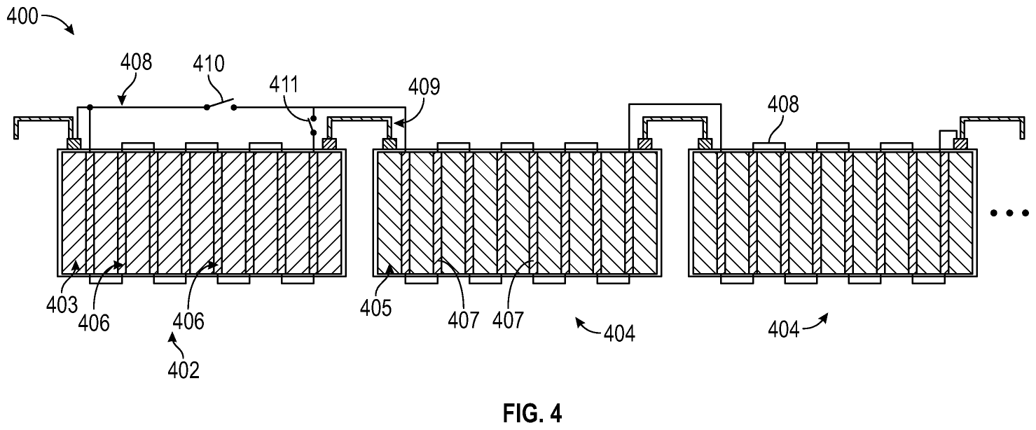

Referring now to FIG. 4 a schematic diagram illustrating a heating system for mixed chemistry battery 400 in accordance with an exemplary embodiment is shown. In exemplary embodiments, the mixed chemistry battery 400 includes a first battery pack 402 that includes a plurality of first battery cells 403 and one or more second battery packs 404 that each include a plurality of second battery cells 405. Each of the battery packs 402, 404 are electrically connected to each other via connectors 409, which may include wires and or conductive plates. In one embodiment, the battery packs 402, 404 are connected to one another, via the connectors 409, in a series configuration.

In exemplary embodiments, the mixed chemistry battery 400 includes a heating system that includes heating elements 406 that are disposed between the first battery cells 403 and heating elements 407 that are disposed between the second battery cells 405. The heating elements 406, 407 are resistive heating elements that can include, but are not limited to, a positive temperature coefficient (PTC) resistance heater, aluminum foil, nickel foil, and the like. In exemplary embodiments, the heating elements 406, 407 are connected to each other via wires 408.

In exemplary embodiments, the heating elements 406, 407 are selectively connected to one or more of the first battery pack 402 and the second battery pack 404 via the operation of switches 410 and 411. In exemplary embodiments, a battery management system is configured to control the heating system via switches 410, 411. In one embodiment, the heating system is configured to be operated in two different modes. In the first mode, switch 410 is closed and switch 411 is open, as a result only the heating elements 407 are configured to receive power from the first battery pack 402 and the second battery pack 404. In the second mode, switch 410 is open and switch 411 is closed, as a result both the heating elements 406, 407 are configured to receive power from the first battery pack 402 and the second battery pack 404. In addition, the heating system can be deactivated by opening switches 410 and 411.

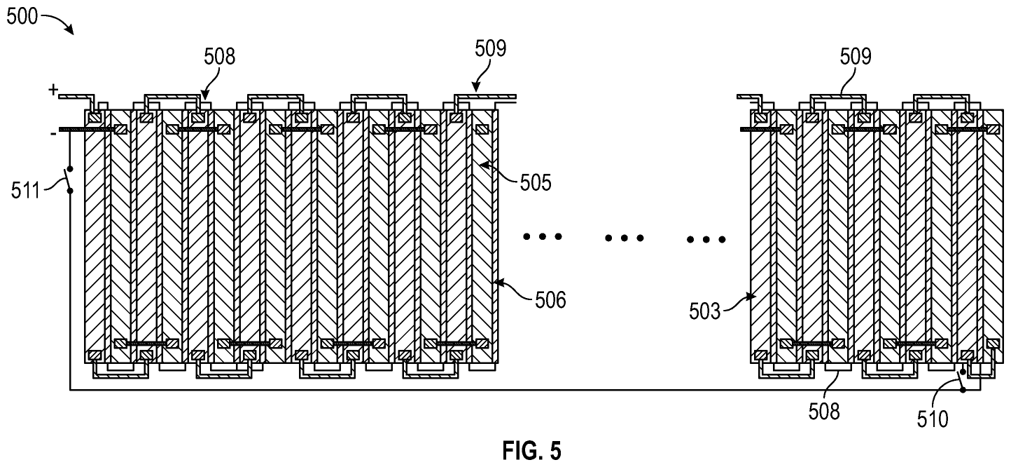

Referring now to FIG. 5 a schematic diagram illustrating a heating system for mixed chemistry battery 500 in accordance with an exemplary embodiment is shown. In exemplary embodiments, the mixed chemistry battery 500 includes a plurality of first battery cells 503 and a plurality of second battery cells 505. Each of the battery cells 503, 505 are electrically connected to each other via connectors 509, which may include wires and or conductive plates. In one embodiment, the battery cells 503, 505 are connected to one another, via the connectors 509, in a series configuration.

In exemplary embodiments, the mixed chemistry battery 500 includes a heating system that includes heating elements 506 that are disposed between the battery cells 503, 505. The heating elements 506 are resistive heating elements that can include, but are not limited to, a positive temperature coefficient (PTC) resistance heater, aluminum foil, nickel foil, and the like. In exemplary embodiments, the heating elements 506 are connected to each other via wires 508.

In exemplary embodiments, the heating elements 506 are selectively connected to one or more of the first battery cells 503 and the second battery cells 505 via the operation of switches 510 and 511. In exemplary embodiments, a battery management system is configured to control the heating system via switches 510 and 511. In one embodiment, the heating system is configured to be operated in two different modes. In the first mode, switch 510 is closed and switch 511 is open, as a result the heating elements 506 are configured to only receive power from the first battery cells 503. In the second mode, switch 510 is open and switch 511 is closed, as a result the heating elements 506 are configured to receive power from both the first battery cells 503 and the second battery cells 505. In addition, the heating system can be deactivated by opening switches 510 and 511.

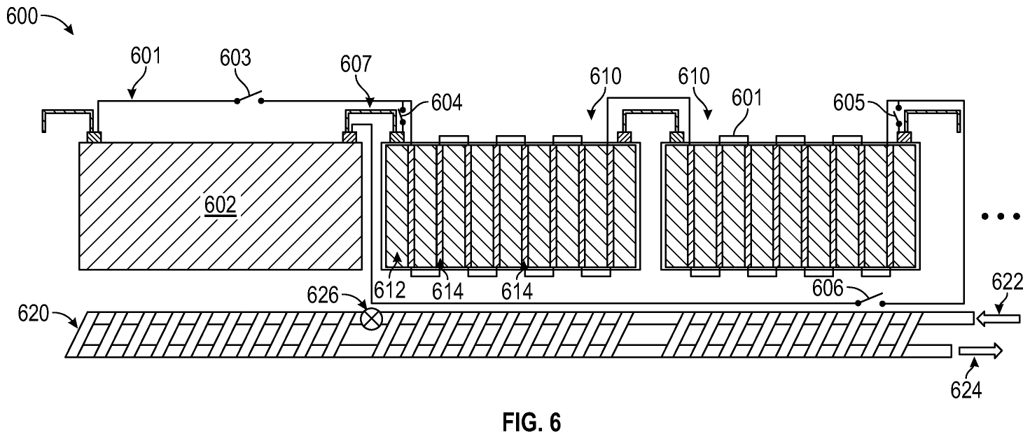

Referring now to FIG. 6 a schematic diagram illustrating a heating system for mixed chemistry battery 600 in accordance with an exemplary embodiment is shown. In exemplary embodiments, the mixed chemistry battery 600 includes a first battery pack 602 that includes a plurality of first battery cells (not shown) and one or more second battery packs 610 that each include a plurality of second battery cells 612. Each of the battery packs 602, 610 are electrically connected to each other via connectors 607, which may include wires and or conductive plates. In one embodiment, the battery packs 602, 610 are connected to one another, via the connectors 607, in a series configuration.

In exemplary embodiments, the mixed chemistry battery 600 includes a heating system that includes heating elements 614 that are disposed between the second battery cells 612. The heating elements 614 are resistive heating elements that can include, but are not limited to, a positive temperature coefficient (PTC) resistance heater, aluminum foil, nickel foil, and the like. In exemplary embodiments, the heating elements 614 are connected to each other via wires 601.

In exemplary embodiments, the heating elements 614 are selectively connected to one or more of the first battery pack 602 and the second battery pack 610 via the operation of switches 603, 604, 605 and 606. In exemplary embodiments, a battery management system is configured to control the heating system via switches 603, 604, 605 and 606. In one embodiment, the heating system is configured to be operated in three different modes. In the first mode, switch 603 is closed, switch 604 is open, switch 605 is open, and switch 606 is closed, as a result the heating elements 614 are only configured to receive power from the first battery pack 602. In the second mode, switch 603 is open, switch 604 is closed, switch 605 is closed, and switch 606 is open, as a result the heating elements 614 are only configured to receive power from the second battery packs 610. In the third mode, switch 603 is closed, switch 604 is open, switch 605 is closed, and switch 606 is open, as a result the heating elements 614 are configured to receive power from both the first battery pack 602 and the second battery packs 610. In addition, the heating system can be deactivated by opening switches 603, 604, 605 and 606.

In exemplary embodiments, the heating system of the mixed chemistry battery 600 also includes a cooling plate 620 that is disposed adjacent to the first battery pack 602 and the second battery packs 610. In exemplary embodiments, the cooling plate 620 is a metal cooling plate that includes one or more cooling channels for cooling fluid to flow through. The cooling plate 620 includes a fluid inlet 622 and a fluid outlet 624 and or more valves 626. In exemplary embodiments, the valves 626 are controlled by the battery management system to selectively control the flow of cooling fluid through the cooling plate 620. In one embodiment, the cooling plate 620 is used to heat the one or more battery pack 602, 610 by circulating a hot fluid through the cooling plate. In another embodiment, the cooling plate 620 is used to cool the one or more battery pack 602, 610 by circulating a cool fluid through the cooling plate.

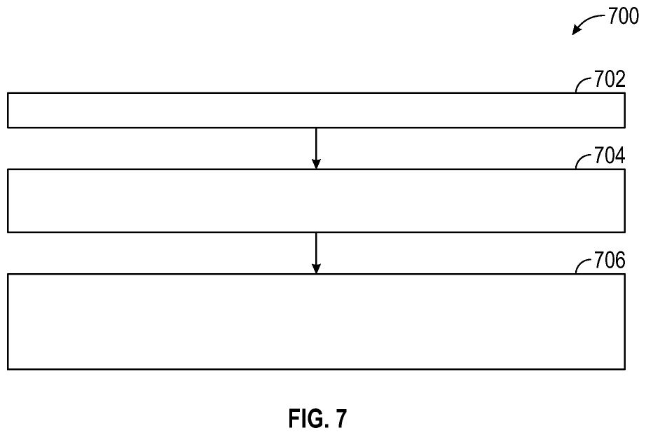

Referring now to FIG. 7, a flowchart diagram illustrating a method 700 for heating a mixed chemistry battery in accordance with an exemplary embodiment is shown. The mixed chemistry battery includes a first battery cell having a first chemistry and a second battery cell having a second chemistry that is different than the first chemistry. In one embodiment, the first chemistry is nickel-manganese cobalt and the second chemistry is lithium iron phosphate. At block 702, the method 700 includes monitoring a temperature of the mixed chemistry battery. At block 704, the method 700 includes connecting a heating system to only the first battery cell based on a determination that the temperature is below a first threshold value. At block 706, the method 700 includes connecting the heating system to the first battery cell and to the second battery cell based on a determination that the temperature is at least the first threshold value. In exemplary embodiments, the first threshold value is approximately negative twenty degrees Celsius.

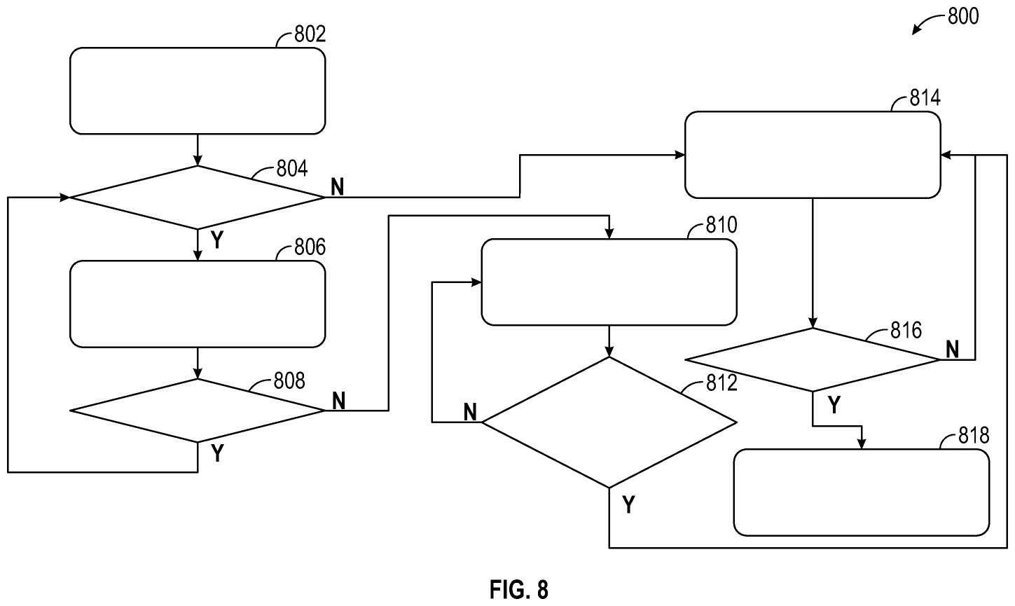

Referring now to FIG. 8, a flowchart illustrating a method 800 for heating system for mixed chemistry battery in accordance with an exemplary embodiment is shown. The mixed chemistry battery includes a first battery cell having a first chemistry and a second battery cell having a second chemistry that is different than the first chemistry. In one embodiment, the first chemistry is nickel-manganese cobalt and the second chemistry is lithium iron phosphate. At block 802, the method 800 begins by monitoring a temperature of the mixed chemistry battery, a state of charge of the first battery cell, and a second state of charge of the second battery cell. At decision block 804, the method determines whether the temperature is below a minimum threshold value. In one embodiment, the minimum threshold value is approximately negative twenty degrees Celsius.

Based on a determination that the temperature is below the minimum threshold value, the method 800 proceeds to block 806 and operates the heating system of the mixed chemistry battery in a first operating mode. In exemplary embodiments, the first operating mode of the heating system includes providing power to the heating system by only connecting the heating system to the first battery cell.

While the heating system is operating in the first operating mode, the temperature of the mixed chemistry battery is monitored and at decision block 808 it is determined whether the temperature of the mixed chemistry battery is less than an intermediate threshold value. In one embodiment, the intermediate threshold value is approximately negative ten degrees Celsius. Based on a determination that the temperature of the mixed chemistry battery is not less than the intermediate threshold value, the method 800 proceeds to block 810 and operates the heating system of the mixed chemistry battery in a second operating mode. In exemplary embodiments, the second operating mode of the heating system includes providing power to the heating system by only connecting the heating system to the second battery cell.

While the heating system is operating in the second operating mode, the state of charge of the first battery cell and a second state of charge of the second battery cell are monitored. At decision block 812 it is determined whether a difference between the first state of charge and the second state of charge is less than a maximum offset. In exemplary embodiments, the maximum offset is less than ten percent. Based on a determination that the difference between the first state of charge and the second state of charge is less than the maximum offset, the method proceeds to block 814 and operates the heating system of the mixed chemistry battery in a third operating mode. Based on a determination that the difference between the first state of charge and the second state of charge is greater than the maximum offset, the method 800 proceeds to return to block 810 and continues operating the heating system in the second operating mode.

Based on a determination that the temperature is at least the minimum threshold value, the method 800 proceeds to block 814 and operates the heating system of the mixed chemistry battery in a third operating mode. In exemplary embodiments, the third operating mode of the heating system includes providing power to the heating system by connecting the heating system to both the first battery cell and the second battery cell. While the heating system is operating in the third operating mode, the temperature of the mixed chemistry battery is monitored. At decision block 816 it is determined whether the temperature is above a maximum threshold value. In exemplary embodiments, the maximum threshold value is approximately twenty degrees Celsius. Based on a determination that the temperature above the maximum threshold value, the method 800 proceeds to block 818 and the heating system is deactivated. Based on a determination that the temperature is below the maximum threshold value, the method 800 returns to block 814 and the heating system continues to operate in the third operating mode.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, (i.e., one, two, three, four, etc.). The terms “a plurality” may be understood to include any integer number greater than or equal to two, (i.e., two, three, four, five, etc.). The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A mixed chemistry battery of a vehicle, the mixed chemistry battery comprising:
a first battery cell having a first chemistry;
a second battery cell having a second chemistry that is different than the first chemistry;
a sensor configured to measure a temperature of the mixed chemistry battery;
a heating system configured to heat the second battery cell; and
a battery monitoring system configured to selectively connect the heating system to at least one of the first battery cell and the second battery cell based upon the temperature of the mixed chemistry battery.

2. The mixed chemistry battery of claim 1, wherein the first chemistry is nickel-manganese cobalt and the second chemistry is lithium iron phosphate.

3. The mixed chemistry battery of claim 1, wherein the first battery cell is connected to the second battery cell in series.

4. The mixed chemistry battery of claim 1, wherein the battery monitoring system is configured to connect the heating system to only the first battery cell based upon the temperature being below a first threshold value.

5. The mixed chemistry battery of claim 1, wherein the battery monitoring system is configured to connect the heating system to the first battery cell and the second battery cell based upon the temperature being at least a first threshold value.

6. The mixed chemistry battery of claim 1, wherein the heating system includes one or more resistive heating layers disposed adjacent to the second battery cell.

7. The mixed chemistry battery of claim 1, wherein the heating system includes a cooling plate disposed adjacent to the first battery cell and the second battery cell.

8. The mixed chemistry battery of claim 7, wherein the cooling plate is a liquid cooled and includes one or more valves that are controlled by the battery monitoring system based upon the temperature of the mixed chemistry battery.

9. A method for heating a mixed chemistry battery having a first battery cell having a first chemistry and a second battery cell having a second chemistry that is different than the first chemistry, the method comprising:
monitoring a temperature of the mixed chemistry battery;
based on a determination that the temperature is below a first threshold value, connecting a heating system to only the first battery cell; and
based on a determination that the temperature is at least the first threshold value, connecting the heating system to the first battery cell and to the second battery cell.

10. The method of claim 9, wherein the first chemistry is nickel-manganese cobalt and the second chemistry is lithium iron phosphate.

11. The method of claim 9, wherein the first battery cell is connected to the second battery cell in series.

12. The method of claim 9, wherein the heating system includes one or more resistive heating layers disposed adjacent to the second battery cell.

13. The method of claim 9, wherein the heating system includes a cooling plate disposed adjacent to the first battery cell and the second battery cell.

14. The method of claim 13, wherein the cooling plate is a liquid cooled and includes one or more valves that are controlled by the battery monitoring system based upon the temperature of the mixed chemistry battery.

15. The method of claim 9, further comprising deactivating the heating system based on a determination that the temperature is above a maximum threshold value.

16. A method for heating a mixed chemistry battery having a first battery cell having a first chemistry and a second battery cell having a second chemistry that is different than the first chemistry, the method comprising:
monitoring a temperature of the mixed chemistry battery;
monitoring a first state of charge of the first battery cell;
monitoring a second state of charge of the second battery cell;
based on a determination that the temperature is below a minimum threshold value, connecting a heating system to only the first battery cell;
based on a determination that the temperature is above an intermediate threshold value, connecting the heating system to only the second battery cell; and
based on a determination that the temperature is above the intermediate threshold value and that a difference between the first state of charge and the second state of charge is less than maximum offset, connecting the heating system to the first battery cell and to the second battery cell.

17. The method of claim 16, further comprising deactivating the heating system based on a determination that the temperature is above a maximum threshold value.

18. The method of claim 16, wherein the first chemistry is nickel-manganese cobalt and the second chemistry is lithium iron phosphate.

19. The method of claim 16, wherein the heating system includes one or more resistive heating layers disposed adjacent to the second battery cell.

20. The method of claim 16, wherein the heating system includes a cooling plate disposed adjacent to the first battery cell and the second battery cell.
